(19) United States
(12) Patent Application Publication
(10) Pub. No.: US 2006/0156393 A1
(43) Pub. Date: Jul. 13, 2006

(54) Access control trimming

(75) Inventors: Peter K. Harwood, Snoqualmie, WA (US); James R. Sturms, Seattle, WA (US); Ziyi Wang, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/035,381

(22) Filed: Jan. 12, 2005

(51) Int. Cl. G06K 9/00

(52) U.S. Cl. 726/7

(57) ABSTRACT

Determining the user access controls to be included in a graphical user interface is disclosed. In response to a user logging onto a computing device, the level of access to be accorded to the user is determined. In response to the logged-on user requesting a page, the user access controls of the page that the logged-on user will have access to is determined. The determination is made by retrieving a page template for the requested page, the page template including generic access recognition instructions. Access data that describes the level of access accorded the user is also retrieved. Then the requested page is composed. When composed, the requested page includes access control rendering instructions that are based on the generic access recognition instructions and the access data. As a result, when the page is rendered, the resultant display includes user access control accessible to a user. Access controls that are not accessible to the user are either not displayed or displayed in a different manner, such as in phantom.

### FIELD OF THE INVENTION

The present invention relates to computer software, and more particularly, to limiting access to the content and controls available in a computer user interface.

### BACKGROUND OF THE INVENTION

In order to enable humans to interact with computing devices, such as computers, personal digital assistants (PDAs), cellular telephones, etc., computer system designers often provide a graphical user interface (GUI) consisting of at least one electronic display and one or more input devices. More specifically, a typical configuration is comprised of, but not limited to, one or more electronic displays and a keyboard and mouse, or other electronic pointing device for interacting with the display(s).

Computer-generated information is represented on the display(s) as text, graphics, animation, video, or other visual imagery. This information representation is also referred to as “content.” Computer controls are represented on the display(s) as images of buttons, dropdown menus, and the like, well known to those skilled in the art. The user interacts with the computer by viewing the content and using the information represented by the content to make a decision to invoke one or more computer controls by using an input device to select and activate a selected control.

Software modules that may use a graphical user interface (GUI) include, but are not limited to, applications, system tools, networked applications, and Web browsers, running on desktop and laptop computers. In addition to computers, PDAs, and cellular telephones mentioned above, other computing devices that may include a graphical user interface include, but are not limited to, electronic information kiosks, in-vehicle navigation devices, printers, copiers, photographic and video cameras, and other electronic imaging or image capture devices.

Often not all users of computing devices are permitted to view, modify, or otherwise access all available GUI content and/or controls. User limits are put in place for a variety of reasons. A typical reason is to ensure the security of the computing device and the information the device contains.

One of the measures used to limit access to, e.g., enforce the security of, a computing device is to require that users identify themselves before gaining access to the device. This is often done by presenting a set of text fields to the user in which the user enters a name, a password, and perhaps other identifying information. When this information is submitted, the computing device searches a list of users to first ensure that a user with the submitted name exists. The computing device then compares the rest of submitted information with the information the computing device has stored for that user. If the user name matches a valid user name in the list and the submitted information correlates with the information associated with that name, the user is allowed access to the computing device. All interaction the user has with the computing device is enabled by the identity assigned to the user. It is this identity that is used to control the access level of the user.

Some GUI implementations allow a user to perform one or more preliminary actions that set up an opportunity for the user to attempt to invoke an unpermitted action. Since the user is restricted from performing the action, the preliminary time and effort expended by the user creating the opportunity is wasted. For example, Web browsers having multiple levels of user access, i.e., low, medium, and high, are often employed in client computing devices included in client-server computing environments. In this environment a user may be presented with a Web browser page containing five buttons. Two of the buttons require a “high” access level, one of the buttons requires a “medium” access level, and the two remaining buttons require a “low” access level.

While a user with a medium level of access is allowed to view all five buttons, because of the access levels associated with the buttons, such a user is only permitted to interact with three of the buttons: the one “medium” level button and two “low” level buttons. A medium level of access user is prohibited from interacting with the two “high” level access buttons. If a medium level of access user attempts to interact with one of the two prohibited buttons, the Web browser responds by displaying a warning message or does nothing at all. Besides confusing and frustrating the user, such browser behavior reduces the efficiency of the user's action.

The Web pages which may be displayed by a Web browser are created when a Web browser reads a page's description, interprets the description to produce a page image, and renders the page image into the window of the browser. Such page descriptions are usually sent to the Web browser from a Web page server. Web page descriptions are often generated on a Web page server by a page composition software component embedded in the Web server or supporting computing devices.

One solution to the foregoing problem proposed by the prior art is to modify the page composition software to allow it to read the information concerning the user's level of access and generate a page description which contains descriptions of only those controls allowed by the user's access level. In this example, a page rendered using such a page description would only display the controls accessible by the user. By eliminating unaccessible controls, which may lead unauthorized users into performing “dead end” preliminary actions, the time, effort, and patience of the user is spared. In the foregoing example, the two “high” level buttons would contain high level access instructions. Since the user in this example has only a “medium” access level, the modified page composition component would prevent the “high” level buttons from being made visible, i.e., not displayed, to the user. Alternatively, the unaccessible level buttons could be displayed in a form that indicates the unaccessibility of the “high” level buttons. The two “high” level buttons could be shown in phantom, for example.

While the foregoing solution provides the desired effect, i.e., the solution prevents users from performing dead end actions, the solution has a number of disadvantages. Included in the disadvantages is a requirement that each control that may appear in a page description must have computer instructions embedded in the page composition component that can read and apply access level information to the generation of control descriptions. Such computer instructions are often manually written for every possible access situation that may arise. Designing and writing such instructions consumes programmers' time and allows inadvertent errors to be inserted when the instructions are written. A second disadvantage is the likely need to change the instructions if certain aspects of the control or the access model change. As with the first noted disadvantage, computer instruction changes consume programmers' time and allow inadvertent errors to be inserted into the changed custom computer instructions. A third disadvantage is a requirement that the computer instructions be written in the same way for all similar controls. If this requirement is not met, the controls are likely to behave in different, often unpredictable, ways.

What is needed is a method and apparatus that will prevent a user of a graphical user interface from accessing controls that, because of security or other restrictions, the user is prohibited from interacting with, without requiring that page composition components be modified to provide access restriction for each and every control. The present invention is directed to providing such a method and apparatus of access control trimming.

### SUMMARY OF THE INVENTION

In accordance with the present invention, a method and apparatus, including computer-readable medium, that limits, i.e., trims, a computer user's access to specific page controls is provided. Generic access recognition instructions are provided in a page composition component. In contrast with the prior art, the generic access recognition instructions read access information for the controls from a data structure instead of embedding the access information in the instructions themselves. After reading the access information, the page composition component determines if the related control should be made accessible to the user. If the control is determined to be accessible, it is made available to the user. If the control is determined not to be accessible, it is not made available to the user. Preferably, the generic access recognition code is expressed as XML in the metadata of the related control.

As will be appreciated from the foregoing description, the access information is external to the page composition component. As a result, the access information is available to third-party developers. Access determination external to the page composition component allows all controls to employ a common access model and common computer instructions. Not only does this allow third-party developers to set control access, it keeps the access model and instructions consistent from control to control and reduces the number of instructions needed to implement access determination. Controls whose access is determined in such a way are herein referred to as “trimmable controls”.

A control may be included in a graphical user interface (GUI) that, if made available, i.e., accessible, to a user, is actuable by a suitable input device, such as a mouse, for example. Alternatively, a control may be part of a set of controls and/or part of content presentable to a user.

If a trimmable control is determined not to be accessible, the control is not presented, e.g., displayed, for user interaction. Alternatively, if the control is determined not to be accessible, the control is presented, but not enabled for user interaction. Preferably presented but not accessible controls are displayed in a different manner than presented accessible controls.

As will be readily appreciated from the foregoing summary, the present invention is directed to enhance a user's experience by increasing the convenience of a user interface. The present invention is not intended to enforce computer device access, rather the invention is intended to help users avoid the inconvenience of some aspects of access.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram illustrating some of the elements of a basic computing device;

FIG. 2 is a pictorial diagram illustrating a typical Web browser page;

FIG. 3 is a pictorial diagram illustrating a typical Web browser page similar to that shown in FIG. 2 with some controls hidden due to access restrictions;

FIG. 4 is a pictorial diagram illustrating a typical Web browser page similar to that shown in FIG. 2 with an entire set of controls hidden due to access restrictions;

FIG. 5 is a diagram illustrating an exemplary access rights data structure expressed as an XML element;

FIG. 6 is a diagram illustrating an exemplary page template data structure expressed as an XML element; and

FIG. 7 is a flow diagram illustrating how a renderable page presenting only permitted controls is generated.

### DETAILED DESCRIPTION OF THE PREFERRED EMBODIMENT

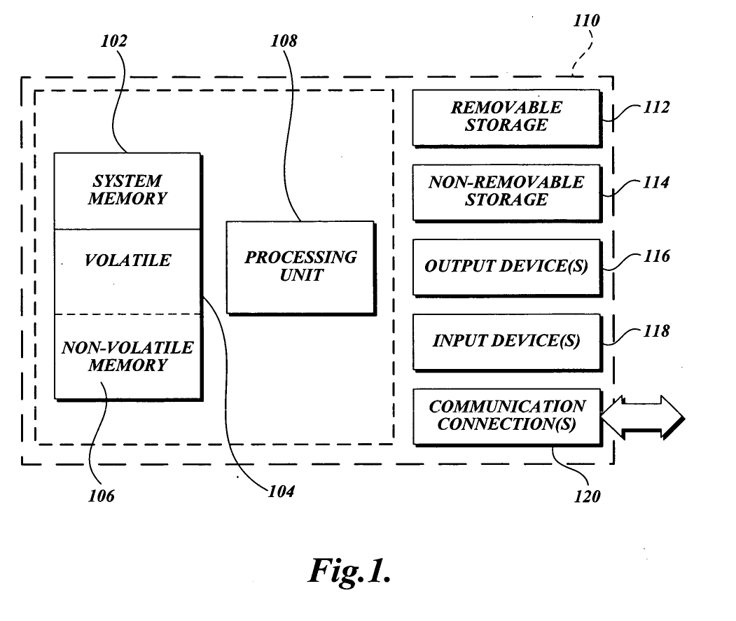

FIG. 1 and the following discussion are intended to provide a brief, general description of a computing system suitable for implementing various features of the invention. While the computing system will be described in the general context of a personal computer usable as a standalone computer, or in a distributed computing environment where complimentary tasks are performed by remote computing devices linked together through a communication network, those skilled in the art will appreciate that the invention may be practiced with many other computer system configurations, including multi-processor systems, mini computers, mainframe computers, and the like. In addition to the more conventional computer systems described above, those skilled in the art will recognize that the invention may be practiced on other computing devices including laptop computers, tablet computers, personal digital assistants, cellular telephones, and other computing devices that may include a graphical user interface include, but are not limited to, electronic information kiosks, in-vehicle navigation devices, printers, copiers, photographic and video cameras, and other electronic imaging or image capture devices, and the like.

While the implementation of the computing system will be described in the general context of an electronic computer, those skilled in the art will appreciate that the invention may be practiced with many other computer system implementations including but not limited to, optical, photonic, pneumatic, and fluidic computers.

While aspects of the invention may be described in terms of application programs that run on an operating system in conjunction with a personal computer, those skilled in the art will recognize that those aspects also may be implemented in combination with other program modules. Generally, program modules include routines, programs, components, data structures, etc., and perform particular tasks or implement particular abstract data types.

While aspects of the invention may be described in terms of graphical user interfaces that are supported by, or integrated with, program modules, those skilled in the art will recognize that those aspects may also be implemented in audible or other types of user interfaces and as user interaction modes.

With reference to FIG. 1, an exemplary system for implementing the invention includes a computing device, such as device 110. In its most basic configuration, computing device 110 typically includes a processing unit 108 and system memory 102. Depending on the exact configuration and type of computing device, system memory may include volatile memory 104 (such as RAM), non-volatile memory 106 (such as ROM, flash memory, etc.), or some combination of the two. Additionally, the computing device 110 may include mass storage (removable storage 112 and/or non-removable storage 114) such as magnetic or optical disks or tape. Similarly, computing device 110 may also include one or more input device(s) 118, such as a mouse and keyboard, and/or output device(s) 1 16, such as a display. The computing device 110 may further include network connection(s) 120 to other devices, such as computers, networks, servers, etc., using either wired or wireless media. Because all of these devices are well known in the art they are not discussed further here.

Computing device 110 typically includes at least some form of computer-readable medium, computer-readable media can be any available media that can be accessed by computing device 110. By way of example, and not limitation, computer-readable media may comprise computer storage media and communication media. As noted above, computer storage media includes volatile and non-volatile, removable and non-removable computer-readable instructions, data structures, program modules, or other data. Computer storage media includes, but is not limited to, RAM, ROM, EEPROM, flash memory or other memory technology, CD-ROM, digital versatile disks (DVD), or other optical storage, magnetic cassettes, magnetic tape, magnetic disk storage, or other magnetic storage devices, or any other medium which can be used to store desired information accessible by computing device 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to include information in the signal. By way of example, and not limitation, communication media includes wired media, such as a wired network or direct wired connection, and wireless media such as acoustic, RF, infrared and other wireless media. Combinations of any of the above should also be included in the scope of computer-readable media.

Secure access to the computing device shown in FIG. 1 is accomplished by requiring that users identify themselves before gaining access to said device. Those skilled in the art will be familiar with a common log-in procedure in which a user is presented with a set of text fields that enable the user to submit a name, a password, and perhaps other identifying information. This information is submitted to the computer system which generates unique identity data that is assigned to the user. This identity data is used in conjunction with other data, described below, to determine which controls are presented to a user.

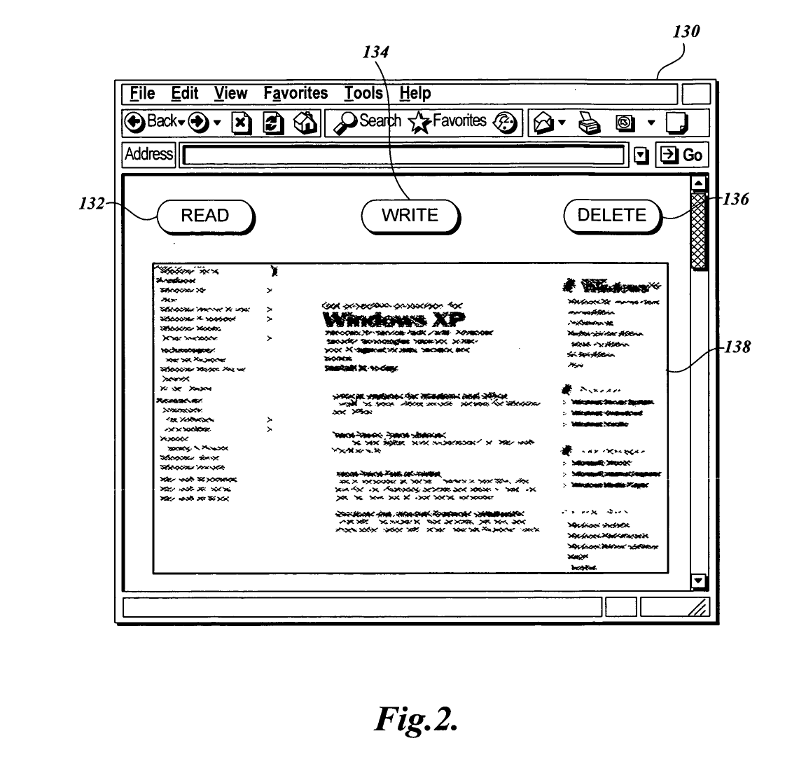

FIG. 2 illustrates a typical Web browser page that includes a plurality of controls—in the illustrated case, three controls, a read control 132, a write control 134, and a delete control 136. The read control 132 invokes a file reading function, the write control 134 invokes a file writing function, and the delete control 136 invokes a file deletion function. Since none of the controls illustrated in FIG. 2 are restricted with respect to a logged on user accessing the illustrated Web browser page, all three controls are presented to the user.

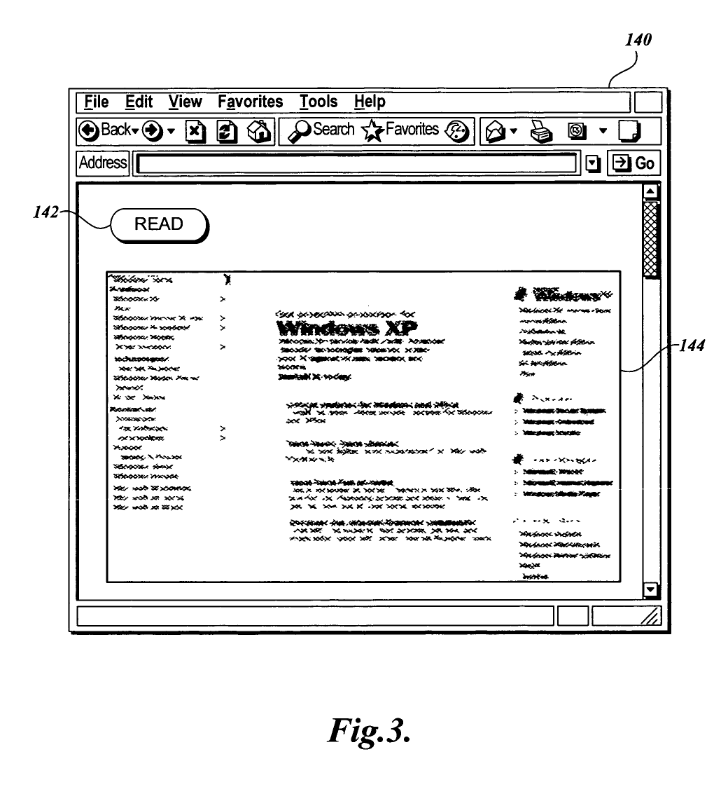

FIG. 3 illustrates the same Web browser page shown in FIG. 2 except that two of the three controls are access restricted with respect to the logged on user accessing the illustrated Web browser page. The two controls (write and delete) that are restricted do not appear in the Web page because they are not available to the user.

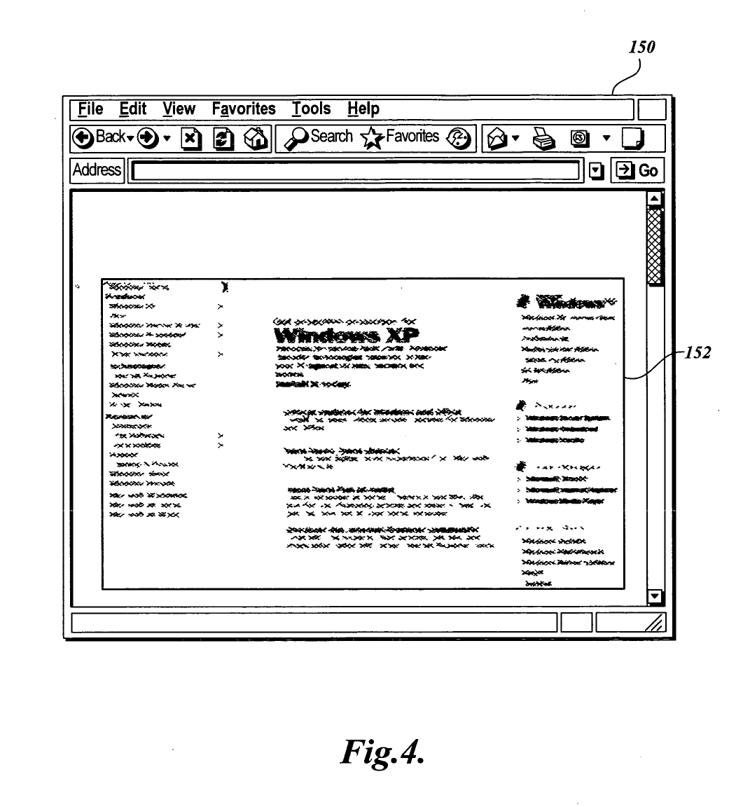

FIG. 4 illustrates the same Web browser page shown in FIGS. 2 and 3, except that the entire set of controls is access restricted with respect to the logged on user accessing the illustrated Web browser page. Since the entire set is restricted, none of the controls (read, write or delete) appear in the Web page. Unlike the situation presented in FIG. 3, it is the control set and not the individual controls that are access restricted.

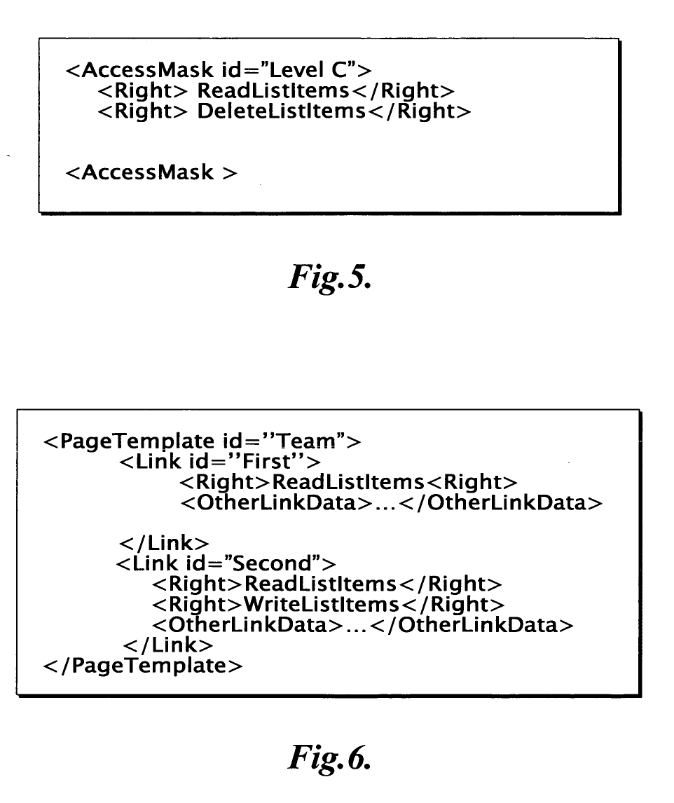

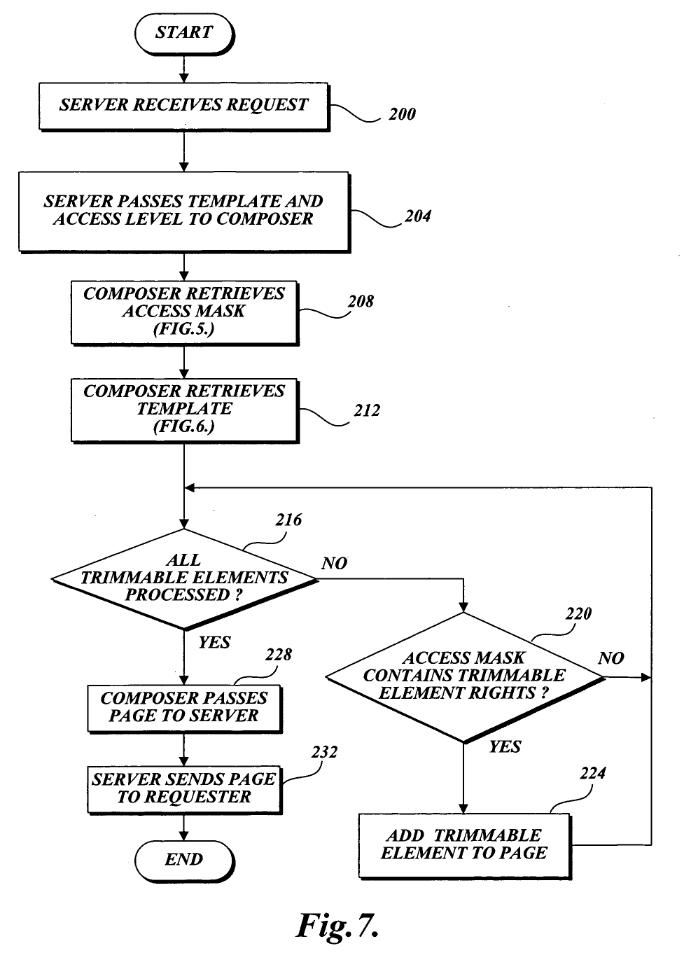

FIG. 5 illustrates an access rights data structure, i.e., a data structure containing information about the access rights granted for a particular access level determined by the identity of a logged-on user. The illustrated access rights data structure, also called herein an access mask, contains one or more “Right” elements which represent access rights and is described in more detail below in connection with the description of the flow diagram illustrated in FIG. 7. FIG. 6 illustrates an exemplary page template data structure, i.e., a data structure containing information describing a page template. While a page template data structure may contain one page element, a page template data structure usually contains multiple page elements. Page elements contain the data that specify controls in a page. Such controls include, but are not limited to, buttons, navigation links, tool bars, tool bar buttons, menus, and menu items. Page elements whose access is controlled are trimmable. The page elements in the exemplary page template data structure shown in FIG. 6 are navigation links and are each delimited by a pair of “Link . . . /Link” tags. Each page element in the page template is identified with a unique name. For example, in FIG. 6 the first page element is a “Link” named “First.” A page element in the page template may contain one or more “Right” elements and other information concerning what the page element represents. If a page element in a page template contains a “Right” element, the “Right” element is used (FIG. 7) to determine if a logged on user has access to the page element. In this example a page element that contains at least one “Right” element is a “trimmable element.”

While the data structures illustrated in FIGS. 5 and 6 are expressed as XML elements, the data structures could be expressed by other declarative means and, thus, the illustrated structures should be construed as exemplary and not as limiting.

The data structures illustrated in FIGS. 5 and 6 are used in the exemplary process shown in the FIG. 7 flow diagram. At block 200, a server receives a request from a client for a page description and derives from the request the location of the template for the page, the location of the specific data for the page, and the user's access level. At block 204, the server passes the information acquired at block 200 to a page composing software component referred to hereafter as the “page composer.”

At block 208, the page composer uses the access level to retrieve the access mask shown in FIG. 5 which is identified as a “Level C” access mask. At block 212, the page composer uses the location of the page template to retrieve the page template shown in FIG. 6 which is identified as a “Team” page template. The page composer also starts to build a new page description for rendering.

As part of the building of the new page description for rendering, each page element in the “Team” page template is sequentially processed by the page composer. At block 216, a test is made to determine if all trimmable elements have been processed. If all trimmable elements have not been processed, the process proceeds to block 220. At block 220, the page composer reads the rights information about the “next” trimmable element in the sequence and compares those rights to the retrieved “Level C” access mask (block 208). As noted above, with respect to FIG. 6, each page element is represented in the “Team” page template. If, in the present example, all of the rights in the “next” page element are in the list of rights in the “Level C” access mask, a description of a user access control, such as a button, drop down menu, etc., is placed into the page description 224. Then the process cycles back to test block 216. Alternatively, if all of the rights on the “next” trimmable element are not in the list of rights in the “Level C” access mask, nothing is added to the page description. Rather, the process cycles directly back to test block 216.

Using the information shown in FIGS. 5 and 6 as an example, it can be seen that the page element identified as “First” (FIG. 6) would cause a control to be inserted into the page description because the “First” page element only requires that the access mask (FIG. 5) contain a right for “ReadListItems.” In contrast, the page element identified as “Second” (FIG. 6) would not cause a control to be inserted into the page description because while the “Second” page element contains a right for both “ReadListItems” and “WriteListItems,” only a right for “ReadListItems” is contained in the access mask.

During the aforementioned process or after all of the trimmable elements in the “Team” page template have been processed, the page composer may insert additional specific data and other data stores into various elements within the page description. After all of the trimmable elements have been processed, at block 228, the page composer passes the new page description to the server. At block 232, the server sends the page description back to the requestor for rendering.

Unlike controls generated using the prior art, controls developed in accordance with the invention do not contain instructions on how to determine the accessibility of the control. Rather, the page template data structure includes generic access recognition instructions in the form of trimmable elements that are used in combination with an access mask whose level is determined by the identity of the logged-on user to develop the controls to be included in a page when the page is rendered.

As those skilled in the art and others will readily appreciate from the foregoing description, the invention provides a method and apparatus, including a computer-readable medium, suitable for limiting a computer user's access to specific controls in a graphical user interface by inserting a description of a control into a page description when the rights afforded to a user's access level are in accordance with the access rights of the control's description in a page template. While the foregoing description has applied the described process to single controls one at a time, the process is equally applicable to sets of controls. Further, a window containing a set of controls, such as a list of links, may be entirely trimmed if all of the controls, i.e. all of the links are trimmed, i.e., removed from user access. Although the foregoing description only identifies certain types of user controls, those skilled in the art and others will readily appreciate that the present invention is equally applicable to any user-accessible page element (generically a control) that may require access restrictions. Further, which the exemplary process (FIG. 7) has been described in a system wherein a server receives a request from a client, as those skilled in the art and others will appreciate, the process is equally applicable to a stand alone computing device, i.e., a computing device wherein the page template, composer, etc., are all contained in the requesting computing device. Thus, the foregoing description should be construed as illustrative and not as limiting upon the present invention.

While the presently preferred embodiment of the invention has been illustrated and described, it will be appreciated that various changes can be made therein without departing from the spirit and scope of the invention. For example, in addition to the variations described above, rather than not displaying inaccessible controls, inaccessible controls may be rendered in a form indicating they are not accessible. The inaccessible controls may be shown in phantom, i.e., grayed out, or, in some other way, distinguished from accessible controls, for example. Also it is to be understood that it is possible to differentiate accessible and inaccessible controls in ways other than those specifically described herein.

The embodiments of the invention in which an exclusive property or privilege is: claimed are defined as follows:

1. A method for determining the user access controls to be included in a graphical user interface, said method comprising:
(a) in response to a user logging onto a computing device, determining the level of access to be accorded the user; and
(b) in response to a logged-on user requesting a page that includes user access controls, determining which user access controls of said page the logged-on user will have access to by:
(1) retrieving a template for the requested page (“page template”);
(2) retrieving access data based on the level of access accorded to the user;
(3) determining which user access controls to include in the requested page based on said retrieved access data; and
(4) composing the requested page so as to include the user controls determined to be included in the requested page.

2. The method of claim 1 wherein said page template is retrieved by a page composer.

3. The method of claim 2 wherein said access data is also retrieved by said page composer.

4. The method of claim 1 wherein said access data is retrieved by a page composer.

5. The method of claim 1 wherein said page template includes generic access recognition instructions.

6. The method of claim 5 wherein said generic access recognition instructions include page elements associated with user access controls included in said page template, said page elements identifying the access data necessary for the related user access control to be included in the requested page when the requested page is composed.

7. The method of claim 1 wherein controls that are not accessible to the logged-on user are included in the composed page so as to be renderable differently from user access controls.

8. The method of claim 7 wherein the controls that are not accessible to the logged-on user are renderable in phantom.

9. A computer device comprising:
(a) a display for displaying a graphical user interface;
(b) a processor for executing program instructions; and
(c) a program for providing executable instructions to said processor that when executed cause said processor to display a graphical user interface having user accessible controls, said program:
(1) in response to a user logging onto said computing device, determining the level of access to user accessible controls to be accorded to the logged-on user; and
(2) in response to a logged-on user requesting a page that includes user access controls, determining which user access controls of said page the logged-on user will have access to by:
(i) retrieving a template for the requested page, said page template containing generic access recognition instructions for user access controls includable in a page that is composed based on the template; and
(ii) composing said requested page, said composed requested page including executable instructions suitable for rendering said requested page on said display, said executable instructions including instructions for rendering user access controls that are based on said generic access recognition instructions included in said page template and said level of access to said user access controls accorded to the logged-on user.

10. The computer device claimed in claim 9 wherein the generic access recognition instructions include page elements that identify the level of access required for users to access related user access controls.

11. The computer device claimed in claim 9 wherein controls that are not accessible to the logged-on user are displayed differently from user access controls.

12. The computer device of claim 11 wherein the controls that are not accessible to the logged-on user are shown in phantom.

13. A computer-readable medium including computer-executable instructions that when executed cause a computer device to:
(a) determine the level of access to be accorded to a user logging onto said computing device;
(b) in response to a logged-on user requesting a page that includes user access controls, determining which user access controls of said page the logged-on user will have access to by:
(1) retrieving a template for the requested page, said page template containing user access controls;
(2) retrieving access data based on the level of access accorded the user;
(3) based on said retrieved access data, determining which user access controls to include in the requested page when the requested page is rendered ; and
(4) causing said requested page to be rendered on a display such that said user access controls are operable by a user input device.

14. The computer-readable medium claimed in claim 13 wherein said computer-readable medium includes a page composer, said page composer retrieving said page template.

15. The computer-readable medium claimed in claim 14 wherein said page composer also retrieves said access data.

16. The computer-readable medium claimed in claim 13 wherein said computer-readable medium includes a page composer, said page composer retrieving said access data.

17. The computer-readable medium claimed in claim 13 wherein said page template includes generic access recognition instructions.

18. The computer-readable medium claimed in claim 17 wherein said generic access recognition instructions include page elements associated with user access controls included in said page template, said page elements identifying the access data necessary for the related user access control to be included in the requested page when the requested page is rendered.

19. The computer-readable medium as claimed in claim 13 wherein the controls that are not accessible to the logged-on user are displayed differently than user access controls.

20. The computer-readable medium as claimed in claim 19 wherein the controls that are not accessible to the logged-on user are shown in phantom.
